(19) United States
(12) Patent Application Publication
(10) Pub. No.: US 2012/0050175 A1
(43) Pub. Date: Mar. 1, 2012

(54) DISPLAY AND TOUCH PANEL THEREOF

(76) Inventors: Wu-Tung KAO, Taichung City (TW); Chih-Ping Shu, Taichung City (TW); Chi-Feng Chiu, Taichung City (TW)

(21) Appl. No.: 12/870,787

(22) Filed: Aug. 28, 2010

(51) Int. Cl. G06F 3/041

(52) U.S. Cl. 345/173

(57) ABSTRACT

A touch panel of a display disposed on a display panel includes a transparent substrate, a transparent electroconductive layer and an electrode pattern layer vertically stacked together. The electrode pattern layer includes two opposite parallel X-side electrodes and two opposite parallel Y-side electrodes, all of which surround a rectangular area and are disposed on a periphery of the transparent electroconductive layer. Also, a plastic film is disposed on a side surface of the electrode pattern layer opposite the transparent electroconductive layer. Thus, the touch panel needs not the processing of the surface hard layer, so that the manufacturing processes are simplified, the production yield is increased and the manufacturing cost is reduced when the large-scale touch panel is manufactured. Meanwhile, the interference of electromagnetic waves on the transparent electroconductive layer and the electrode pattern layer can be reduced, and the touch certainty and precision can be enhanced.

### BACKGROUND OF THE INVENTION

1. Field of the Invention

The invention relates to a display and a touch panel thereof.

2. Related Art

FIGS. 1 and 2 show a conventional touch-type liquid crystal display.

Referring to FIGS. 1 and 2, the liquid crystal display includes a display panel 20 and a touch panel 10. The touch panel 10 has a transparent substrate 11, a transparent electroconductive layer 12 disposed above the transparent substrate 11, and an electrode pattern layer 13 disposed above the transparent electroconductive layer 12. The electrode pattern layer 13 includes two opposite X-side electrodes 131 and two opposite Y-side electrodes 132, all of which surround a rectangular area and are formed on a periphery portion of the transparent electroconductive layer 12. Furthermore, a hard layer 14 for insulation protection covers an upper surface of the electrode pattern layer 13. The transparent substrate 11 may be a transparent glass substrate or a transparent plastic substrate, while the transparent electroconductive layer 12 may be an indium tin oxide film or an antimony tin oxide film for compensating the distribution curve of an electric field on the transparent electroconductive layer 12. The hard layer 14 may be a silicon dioxide layer or the like. The touch panel 10 is directly disposed above the display panel 20. When the user touches the touch panel 10 through the finger or the conductor, it is possible to obtain the correct position, where the finger or the conductor touches the touch panel 10, according to the nonuniform electric field generated when the finger or the conductor touches the position of the touch panel 10, so that the display panel 20 displays the corresponding work through the circuit and the operation software.

Although the surface capacitive technology has the advantage of easy production, calibration operations have to be performed, and the electromagnetic interference (EMI) and noise problems, which cannot be easily solved, still have to be overcome. According to the environmental factor observation, the EMI problem is a frequently seen design challenge, and becomes more complicated in the mobile phone with the complicated signals. The weather change is also a factor, which cannot be ignored. The touch sensing correctness is affected by the temperature, humidity or raining condition.

The topmost thin silicon dioxide hard layer 14 in the structure of the capacitive touch panel 10 has the hardness reaching 7H, the second layer of the capacitive touch panel 10 is the transparent electroconductive layer 12, and the bottommost transparent substrate 11 functions to shield the electromagnetic waves to keep the touch panel work in the environment without the interference. In fact, however, the hard layer 14 needs to be formed by the semiconductor coating process and its uniformity requirement is high so that it cannot be easily manufactured and has the high cost. Furthermore, the transparent electroconductive layer 12 and the electrode pattern layer 13 of the touch panel 10 tend to be affected by the temperature, humidity or electromagnetic waves in the external environment due to the insufficient thickness of the hard layer 14. In this case, the sensing correctness is affected, the output current is incorrect, the calculated touch position is imprecise, and the requirement of the actual usage cannot be satisfied.

### SUMMARY OF THE INVENTION

It is therefore an object of the invention to provide a touch panel of a display to protect the touch panel from being scratched and reduce the electromagnetic interference, noise and the like.

Also, the invention provides a touch panel of a display so that the touch panel can be placed reversely to enhance its application flexibility.

The invention achieves the above-identified objects by providing a liquid crystal display including a touch panel and a display panel. The touch panel has a transparent substrate, a transparent electroconductive layer, an electrode pattern layer and a plastic film. The transparent substrate is stacked above the transparent electroconductive layer. The transparent electroconductive layer is stacked above the electrode pattern layer surrounding a rectangular area. The plastic film is disposed on a bottom surface of the electrode pattern layer. The touch panel is disposed above the display panel with a side surface of the plastic film facing the display panel.

Thus, the touch panel of the invention has many advantages and utility values, some of which will be listed in the following.

First, the plastic film may be directly used to protect the touch panel of the invention without the processing of the surface hard layer. So, the manufacturing processes can be simplified, the production yield can be enhanced, and the manufacturing cost can be reduced.

Second, the interference of the electromagnetic waves on the transparent electroconductive layer and the electrode pattern layer can be reduced according to the design of the plastic film, so that the calculation certainty and precision of the position of the touch point can be enhanced.

Third, the touch panel may further be reversely disposed so that the touch panel may be stacked on the display panel with the side, having the plastic film, facing the display panel, and the flexibility in the environment and the application can be enhanced.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematically and pictorially decomposed illustration showing the rough architecture of a conventional touch liquid crystal display.

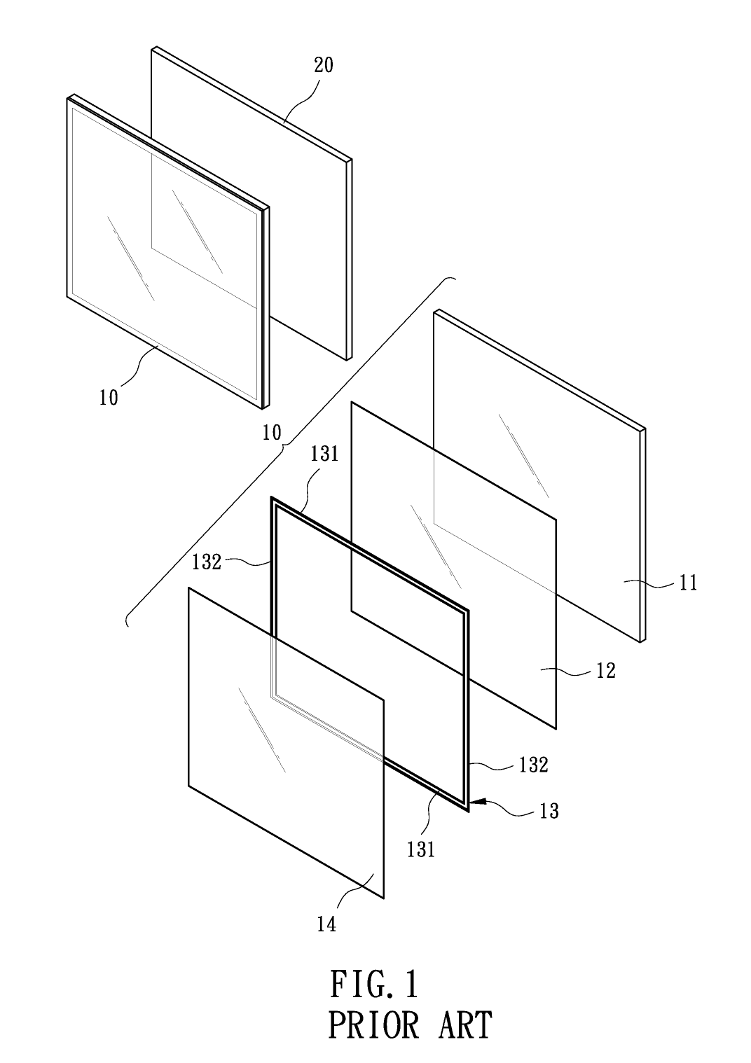

FIG. 2 is a schematically cross-sectional side view showing the rough architecture of the conventional touch liquid crystal display.

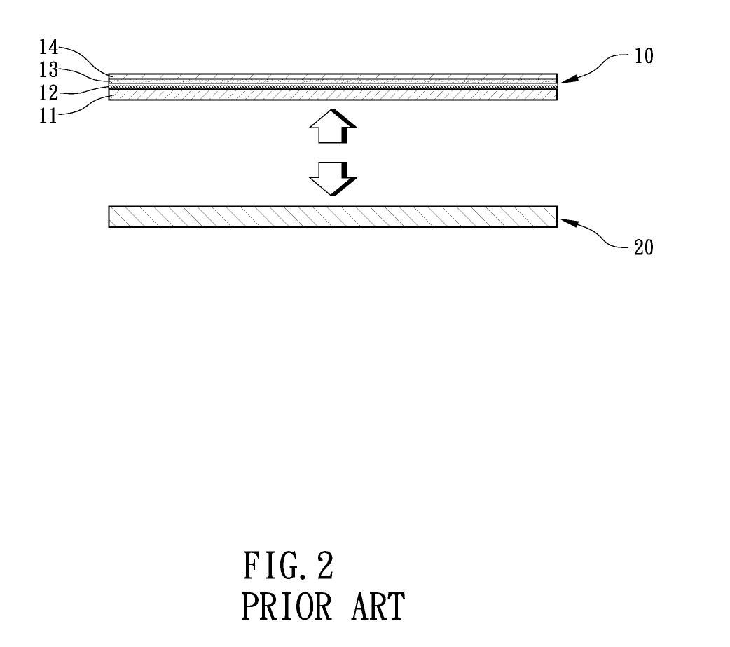

FIG. 3 is a schematically and pictorially decomposed illustration showing a touch panel of a liquid crystal display according to an embodiment of the invention.

FIG. 4 is a schematic top view showing the touch panel of the liquid crystal display of the invention.

FIGS. 5A and 5B are schematically cross-sectional side views showing the touch panel of the liquid crystal display of the invention.

FIGS. 6A and 6B are schematically cross-sectional side views showing a touch panel of a liquid crystal display according to another embodiment of the invention.

FIG. 7 is a schematic illustration showing that the touch panel of the liquid crystal display of the invention receives sensing signals to determine multiple touch positions.

### DETAILED DESCRIPTION OF THE INVENTION

The present invention will be apparent from the following detailed description, which proceeds with reference to the accompanying drawings, wherein the same references relate to the same elements.

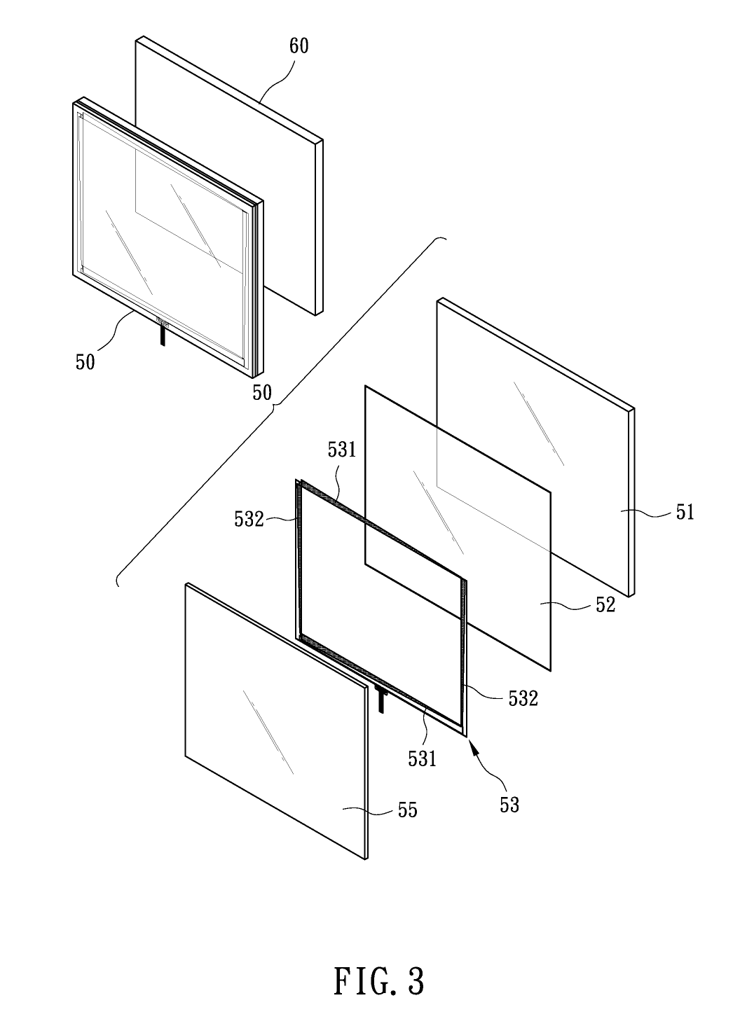

The invention provides a display and a touch panel thereof. As shown in FIG. 3, the display includes a touch panel 50 and a display panel 60, wherein the touch panel 50 works according to the surface capacitive touch technology and is stacked above the display panel 60. Regarding the operation architecture, the system generates one uniform electric field on the touch panel 50. When the finger touches the touch panel 50, the capacitor charging effect appears, and capacitor coupling is formed between the touch panel 50 and the finger so that the capacitor change is generated. The controller only has to measure the current intensities at four corners so that the touch position may be calculated according to the current intensities. Thus, when the user touches the touch panel 50 through the finger or the conductor, the correct position, where the finger or the conductor touches the touch panel 50, may be obtained according to the nonuniform electric field formed, so that the display panel 60 displays the corresponding work through the circuit and the operation software. The touch technology and the constitution of the display panel 60 are not the key characteristics of the invention, and detailed descriptions thereof will be omitted.

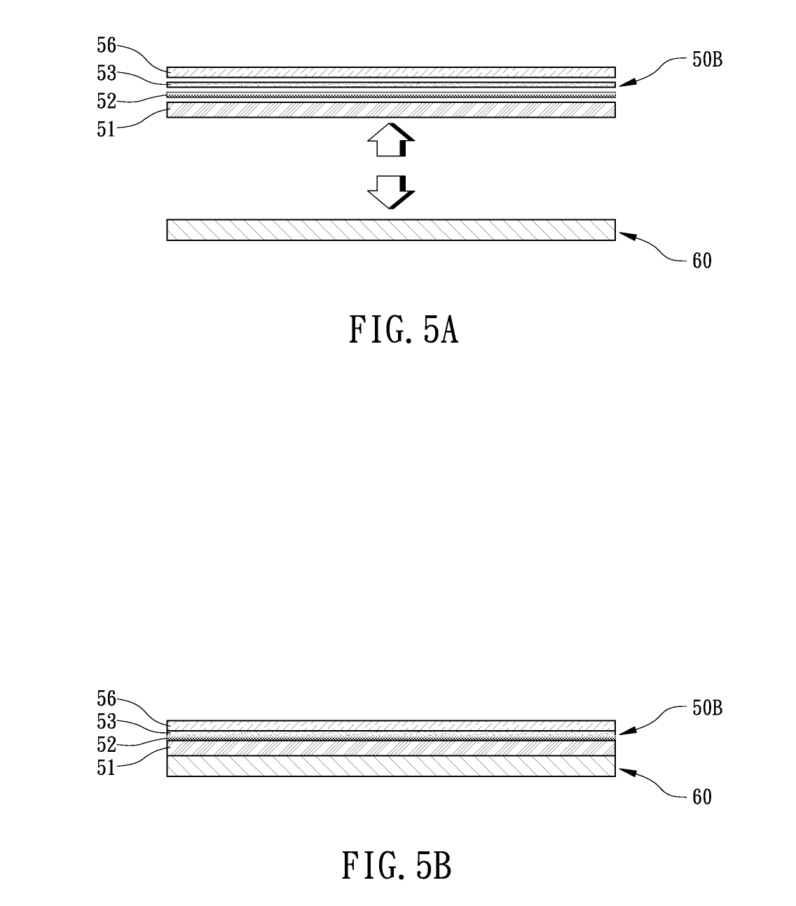

FIGS. 3 to 5B show the detailed structure of the preferred embodiment of the invention. The touch panel 50 has a transparent substrate 51, a transparent electroconductive layer 52 stacked above the transparent substrate 51, an electrode pattern layer 53 stacked above the transparent electroconductive layer 52, and a plastic film 55 having a specific thickness and disposed on an upper surface of the electrode pattern layer 53. The transparent substrate 51 may be a transparent glass substrate or a transparent plastic substrate. The transparent electroconductive layer 52 may be an indium tin oxide film or an antimony tin oxide film. The plastic film 55 may be made of a transparent plastic material, such as PET, PC or the like.

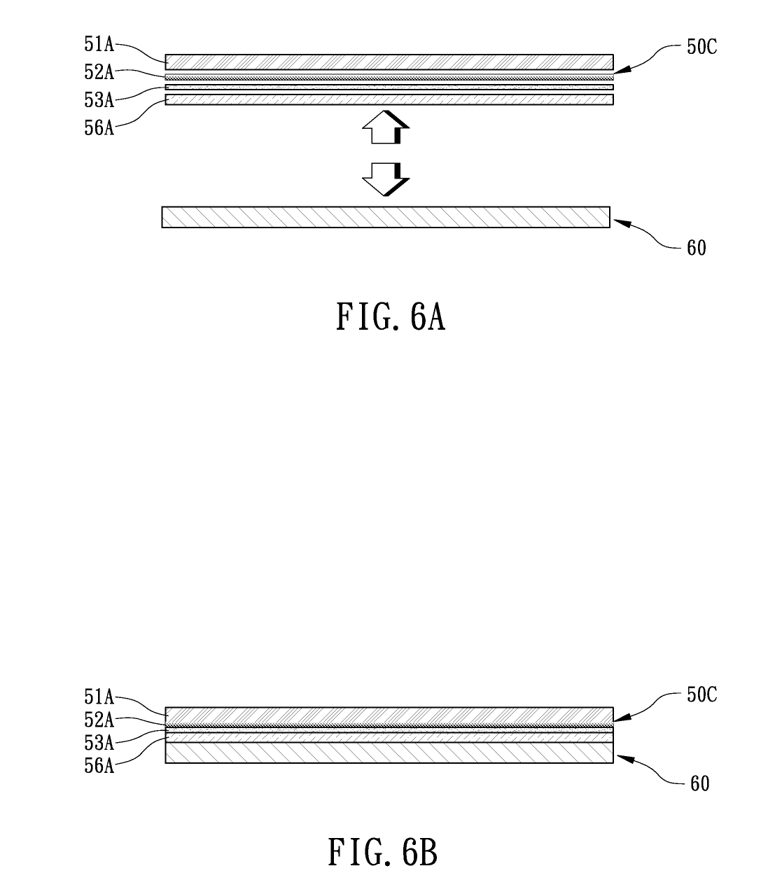

Furthermore, FIGS. 6A and 6B show another embodiment of the invention. Referring to FIGS. 6A and 6B, the display includes a touch panel 50A and a display panel 60. Also, the touch panel 50A has a transparent substrate 51A, a transparent electroconductive layer 52A, an electrode pattern layer 53A and a plastic film 55A. The transparent substrate 51A is stacked above the transparent electroconductive layer 52A. The transparent electroconductive layer 52A is stacked above the electrode pattern layer 53A. The plastic film 55A with a specific thickness is disposed on a bottom surface of the electrode pattern layer 53A. The touch panel 50A is stacked above the display panel 60 with one side of the plastic film 55A facing the display panel 60.

Also, the electrode pattern layer 53 includes two opposite X-side electrodes 531 and two opposite Y-side electrodes 532, all of which surround a rectangular area and are formed on a periphery portion of the transparent electroconductive layer 52. That is, the electrode pattern layer 53 comprises the opposite X-side electrodes 531 respectively disposed on top and bottom edges of the transparent electroconductive layer 52, and the opposite Y-side electrodes 532 respectively disposed on left and right edges of the transparent electroconductive layer 52. The impedances of the X-side electrodes 531 and the Y-side electrodes 532 of the electrode pattern layer 53 are configured in an ascending manner or a descending manner with a common difference or a common ratio toward the same side, so that the impedances of two touch points on the same horizontal or vertical line on the touch panel 50 have a gradient phenomenon to prevent currents, outputted from the electrode pattern layer 53, from offsetting each other when the two touch points are moved, and positions of the two different touch points are calculated according to the currents. The controller (not shown) is utilized to measure the current intensities at four corners so that the X coordinates and the coordinates of the two different touch points can be calculated according to the current intensities. In addition, the X-side and Y-side electrodes 531 and 532 of the electrode pattern layer 53 are formed on the periphery of the transparent electroconductive layer 52 of the touch panel 50 by way of, for example, etching, screen printing, electro-transfer printing or the like. Furthermore, the X-side and Y-side electrodes 531 and 532 of the electrode pattern layer 53 may be made of an electroconductive material, such as a carbon paste, a silver paste, a copper paste or mixtures thereof.

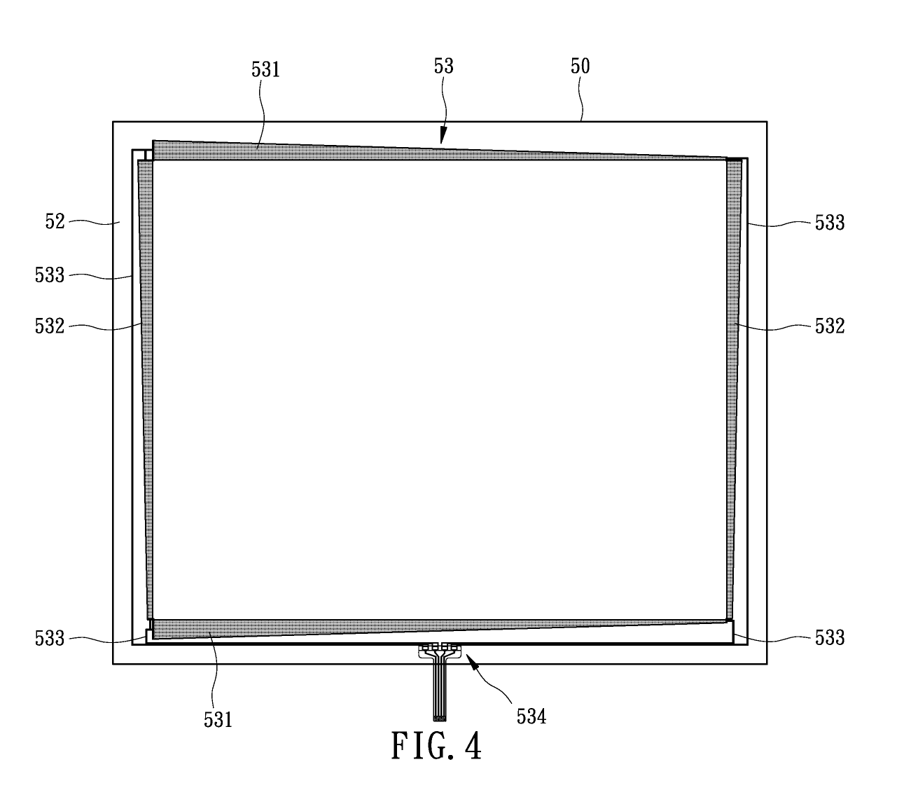

Furthermore, the electrode pattern layer 53 may have four output terminals (see FIG. 4) or eight output terminals. The corresponding terminals of the X-side and Y-side electrodes 531 and 532 of the electrode pattern layer 53 are commonly provided with wires 533 each for measuring the voltage and the current. The wire 533 is made of the electroconductive material, such as the carbon paste, the silver paste, the copper paste or the mixtures thereof. In this invention, the silver paste is adopted, and the wires 533 are disposed on the surface of the non-work area of the touch panel 50 by way of screen printing. Also, the touch panel 50 also has a connection portion 534 for the layout of the other-side terminals of the wires 533 so that the wires 533 can be respectively electrically connected to a controller (not shown) of the touch panel 50.

Thus, the display having the touch panel with the multilayer structure and the low cost and less interference can be obtained.

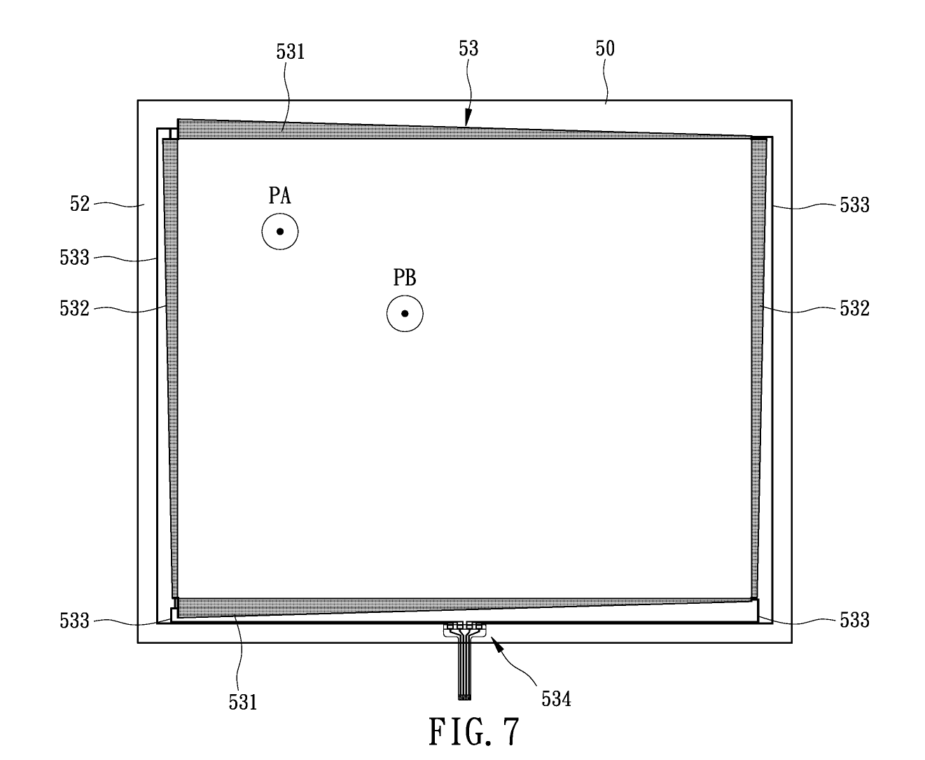

FIG. 7 shows the actual operation of the invention. As shown in FIG. 7, four corners of the X-side and Y-side electrodes 531 and 532 of the electrode pattern layer 53 of the touch panel 50 are connected to four external wires 533 to receive AC sensing signals, respectively, for the measurement of the positions of the two different touch points PA and PB on the touch panel 50.

Regarding the operation architecture, the system generates the nonuniform electric field on the transparent electroconductive layer 52 of the touch panel 50. When the finger touches the touch panel 50, the capacitor charging effect appears, so that the capacitor coupling is formed between the finger and each of the X-side and Y-side electrodes 531 and 532 on the electrode pattern layer 53 of the touch panel 50, and the capacitor change is generated. The controller measures the current intensities at the four corners in this way, and the impedances of the X-side and Y-side electrodes 531 and 532 of the electrode pattern layer 53 are configured in an ascending manner or a descending manner with a common difference or a common ratio toward the same side, so that the impedances of two touch points PA and PB on the same horizontal or vertical line on the touch panel 50 have the gradient phenomenon. Thus, it is possible to prevent currents, outputted from the electrode pattern layer 53, from offsetting each other when the two touch points PA and PB are moved. Thus, the positions of the two different touch points PA and PB can be calculated according to the currents so that the controller can determine the subsequent scaling, rotating or dragging operation to satisfy the requirement of the multiple touch points of the surface capacitive touch panel. In addition, the constitution and the manufacturing difficulty of the multi-point touch panel can be significantly simplified, the manufacturing cost can be reduced, and the added value and the economic effectiveness of the surface capacitive touch panel can be effectively and significantly enhanced.

Because the plastic film 55 directly covers the transparent electroconductive layer 52 and the electrode pattern layer 53 of the touch panel 50, the conventional process of forming the hard layer can be eliminated. In addition, the plastic film 55 of the invention is disposed by way of adhering, while the conventional hard layer is formed by the semiconductor coating process. Thus, the structure of the invention can significantly simplify the processes of manufacturing the large-scale touch panel 50, can enhance the production yield and efficiency, and can reduce the manufacturing cost.

Also, the plastic film 55 protects the transparent electroconductive layer 52 and the electrode pattern layer 53 in the touch panel 50 of the invention. Thus, the influences of the temperature, humidity or electromagnetic waves in the environment on the transparent electroconductive layer 52 and the electrode pattern layer 53 can be reduced so that the electromagnetic interference and noise can be reduced, and the touch certainty and precision can be enhanced. Thus, the liquid crystal display using the touch panel 50 may be applied to the workshop with the poor environmental condition, so that the operation range of the multi-point touch panel can be significantly broadened, and the economic effectiveness can be enhanced.

In the embodiment of FIG. 6, because the plastic film 55A serves as the bottom layer of the touch panel 50A to protect the transparent electroconductive layer 52A and the electrode pattern layer 53A, the interference of the display panel 60 on the touch panel 50A can be reduced. The advantage and the utility value can be obtained, and the touch panel 50A can be reversely disposed on the display panel 60 to enhance the flexibility in the environment and the application.

While the invention has been described by way of examples and in terms of preferred embodiments, it is to be understood that the invention is not limited thereto. To the contrary, it is intended to cover various modifications.

Therefore, the scope of the appended claims should be accorded the broadest interpretation so as to encompass all such modifications.

What is claimed is:

1. A touch panel of a display, the touch panel comprising:
a transparent substrate;
a transparent electroconductive layer stacked above the transparent substrate;
an electrode pattern layer surrounding a rectangular area and stacked above the transparent electroconductive layer; and
a plastic film disposed on an upper surface of the electrode pattern layer, so that the touch panel can be stacked above a display panel of the display to reduce cost and interference.

2. The touch panel according to claim 1, wherein the electrode pattern layer comprises two opposite X-side electrodes and two opposite Y-side electrodes, all of which surround the rectangular area and are formed on a periphery portion of the transparent electroconductive layer, and impedances of the X-side electrodes and the Y-side electrodes are configured in an ascending manner or a descending manner with a common difference or a common ratio toward the same side.

3. The touch panel according to claim 1, wherein the plastic film is made of a transparent plastic material of PET or PC.

4. A display, comprising:
a display panel; and
a touch panel, which comprises:
a transparent substrate;
a transparent electroconductive layer stacked above the transparent substrate;
an electrode pattern layer surrounding a rectangular area and stacked above the transparent electroconductive layer; and
a plastic film disposed on an upper surface of the electrode pattern layer, wherein the touch panel is stacked above the display panel with a side surface of the transparent substrate facing the display panel.

5. The display according to claim 4, wherein the electrode pattern layer comprises opposite X-side electrodes respectively disposed on top and bottom edges of the transparent electroconductive layer, and opposite Y-side electrodes respectively disposed on left and right edges of the transparent electroconductive layer, and impedances of the X-side electrodes and the Y-side electrodes are configured in an ascending manner or a descending manner with a common difference or a common ratio toward the same side.

6. The display according to claim 4, wherein the plastic film is made of a transparent plastic material of PET or PC.

7. A display, comprising:
a display panel; and
a touch panel, which comprises a transparent substrate, a transparent electroconductive layer, an electrode pattern layer and a plastic film, wherein:
the transparent substrate is stacked above the transparent electroconductive layer, the transparent electroconductive layer is stacked above the electrode pattern layer surrounding a rectangular area, the plastic film is disposed on a bottom surface of the electrode pattern layer, and the touch panel is stacked above the display panel with a side surface of the plastic film facing the display panel.

8. The display according to claim 7, wherein the electrode pattern layer comprises opposite X-side electrodes respectively disposed on top and bottom edges of the transparent electroconductive layer, and opposite Y-side electrodes respectively disposed on left and right edges of the transparent electroconductive layer, and impedances of the X-side electrodes and the Y-side electrodes are configured in an ascending manner or a descending manner with a common difference or a common ratio toward the same side.

9. The display according to claim 7, wherein the plastic film is made of a transparent plastic material of PET or PC.
